(19) United States
(12) Patent Application Publication
(10) Pub. No.: US 2025/0248569 A1
(43) Pub. Date: Aug. 7, 2025

(54) METHOD AND APPARATUS FOR MAKING FOODSTUFFS

(71) Applicants: David Alvarez, Los Angeles, CA (US); Jorge Alvarez, Los Angeles, CA (US)

(72) Inventors: David Alvarez, Los Angeles, CA (US); Jorge Alvarez, Los Angeles, CA (US)

(21) Appl. No.: 18/430,061

(22) Filed: Feb. 1, 2024

(51) Int. Cl. A47J 43/20; B30B 1/04; B30B 9/28

(52) U.S. Cl. CPC A47J 43/20; B30B 1/04; B30B 9/28

(57) ABSTRACT

The present system provides a tamale press that is simple to operate and allows a person to make 75-100 tamales per hour. The device is designed to be used to make tamales and avoids the disadvantages of a tortilla press. The device comprises a base with a cavity for receiving a portion of masa to be pressed. A top portion is hingedly coupled to the base and includes a protruding section that approximately matches the dimensions of the cavity in the base. The top portion is closed and a pivoting handle is used to apply pressure to the device, causing the protruding section to press and spread the masa to the borders of the cavity in the base. When the handle and top are lifted, the formed tamale is removed and the next tamale can be produced.

### BACKGROUND OF THE SYSTEM

Making tamales in the prior art involves a combination of traditional and modern machines, each serving a specific purpose in the tamale-making process.

Corn Grinder (Molino): Tamales typically start with masa, a dough made from ground corn. A corn grinder, or “molino,” is used to grind dried corn into masa. Traditional molinos are manual, with a stone or metal grinding mechanism, while modern ones may be electric.

Mixer: After grinding the corn, a mixer is used to combine the masa with other ingredients like lard, broth, and seasoning. This ensures a consistent and well-mixed tamale dough.

Tamale Spreader (Espátula para Tamales): This tool is essential for spreading the masa onto the corn husks. It helps achieve an even layer of dough, making the tamale easier to roll.

Tamale Rolling Machine: In commercial settings or large-scale production, tamale rolling machines are employed to streamline the process of filling and rolling tamales. These machines can automate the assembly line, increasing efficiency.

Steamer: Tamales are traditionally cooked by steaming. Large steamers are used to accommodate multiple layers of tamales. They can be traditional bamboo or metal steamers for home use, while commercial operations may use industrial-sized steamers.

Corn Husk Separator (Separador de Hojas): Corn husks need to be softened before use. A corn husk separator is a machine that efficiently separates and softens the husks, making them pliable for wrapping tamales.

Tamale Press (Prensa para Tamales): In some regions, especially in Central America, a tamale press may be used to shape the tamale and compress the masa around the filling. It simplifies the assembly process for some types of tamales.

Packaging Machines: In commercial production, machines are used to package tamales efficiently. This can include machines for wrapping, sealing, and labeling to prepare the tamales for distribution.

A disadvantage of the current system is that the machines for making tamales are bulky and expensive. They require a large capital outlay, and remove the hand-made feel and taste of traditional methods of making tamales.

A tamale press, also known as a “prensa para tamales” or tamale maker, is a device used to shape and compress masa (corn dough) around the filling when making tamales. Although hand pressing of tamales is considered superior, it is a time consuming process. An experienced person can make approximately 30 to 50 tamales per hour.

Often, a person may try to use a tortilla press to make tamales. However, the tortilla press is not well suited for preparation of tamales, and the results are poor.

### SUMMARY

The present system provides a tamale press that is simple to operate and allows a person to make 75-100 tamales per hour. The device is designed to be used to make tamales and avoids the disadvantages of a tortilla press. The device comprises a base with a cavity for receiving a portion of masa to be pressed. A top portion is hingedly coupled to the base and includes a protruding section that approximately matches the dimensions of the cavity in the base. The top portion is closed and a pivoting handle is used to apply pressure to the device, causing the protruding section to press and spread the masa to the borders of the cavity in the base. When the handle and top are lifted, the formed tamale is removed and the next tamale can be produced.

### BRIEF DESCRIPTION OF THE DRAWINGS

FIG. 1 is a top perspective view of the apparatus in an embodiment.

FIG. 2 is a side plan view of the apparatus of FIG. 1 in an open position.

FIG. 3 is a side plan view of the apparatus of FIG. 1 in a closed position.

### DETAILED DESCRIPTION OF THE SYSTEM

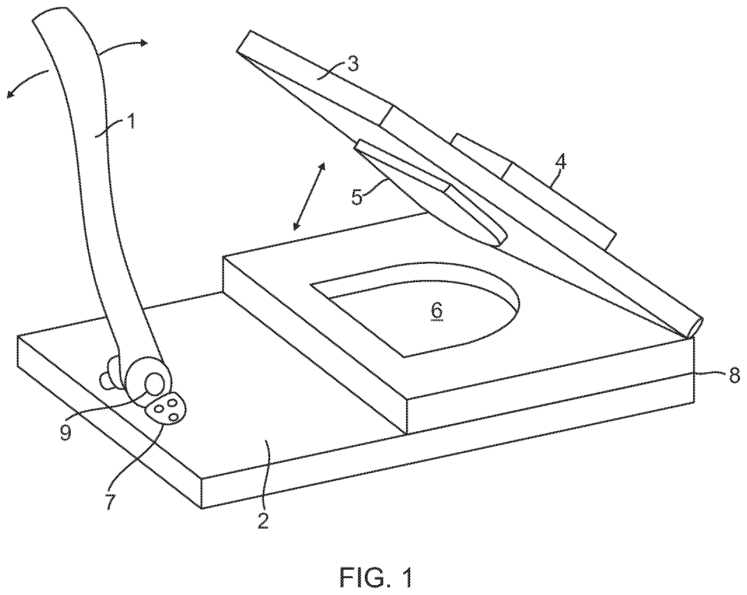

A top perspective view of the press is illustrated in FIG. 1. The press comprises a Handle 1, a Base Plate 2, Compression Plate 3, Fulcrum Block 4, Protrusion Block 5, and Cavity 6. The Handle 1 is coupled via Hinge 7 and Pin 9 to a first end of Base Plate 2. The Base Plate 2 in one embodiment is a two level surface, with a lower level where the Handle 1 is attached and a higher level where the Cavity 6 is formed.

The Compression Plate 3 is hingedly coupled via Hinges 8 to the Base Plate 2 at a second end. The Compression Plate 3 includes a Protrusion Block 5 formed on a bottom surface thereof. The Protrusion Block 5 has the same perimeter shape as the Cavity 6. A Fulcrum Block 4 is formed on an upper surface of the Compression Plate 3.

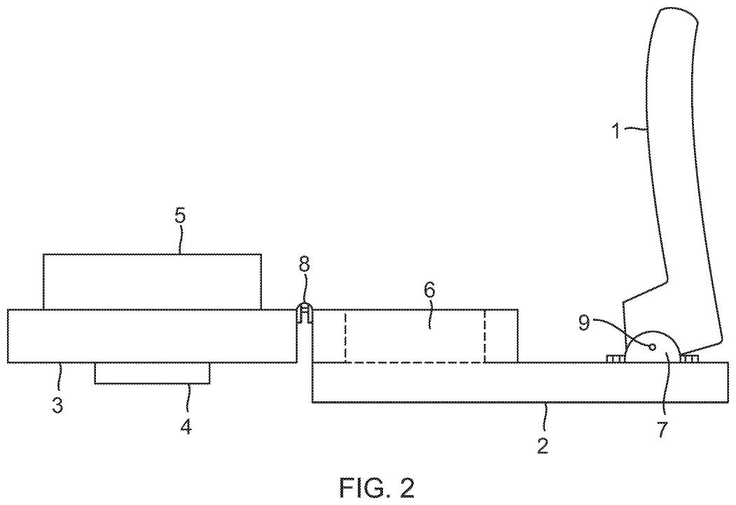

FIG. 2 is a side plan view of the press of FIG. 1 in an open position. The Compression Plate 3 is rotated on Hinge 8 to be parallel to the Base Plate 2. In one embodiment, the Compression Plate is approximately 0.75 inches in thickness and is comprised of wood, metal, plastic, or the like. The Protrusion Block 5 is approximately 0.50 inches thick in one embodiment. The Fulcrum Block 4 is approximately 0.75 inches thick in one embodiment.

The Base Plate 2 shows the Cavity 6 in cross section. In one embodiment, the Cavity 6 is approximately 0.75 inches in depth. The Handle 1 is shown rotated on Hinge 7 and Pin 9 to a fully upright position.

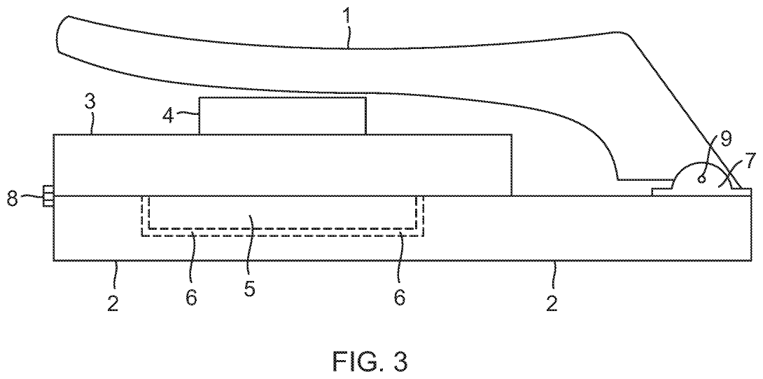

FIG. 3 is a side plan view of the press of FIG. 2 in a closed position. The Compression Plate 3 is rotated on Hinge 8 so that the Compression Plate 3 engages the Base Plate 2. The Protrusion Block 5 is positioned such that it is inserted into Cavity 6. The size of the Protrusion Block 5 and Cavity 6 are selected so that there is a small gap between them when fully inserted.

The Handle 1 is rotated to engage Fulcrum Block 4. A user can press the Handle 1 against Fulcrum Block 4 to apply pressure between the Protrusion Block 5 and Cavity 6.

In operation, the device is open as in FIG. 2, and a portion of masa is placed in Cavity 6. The Compression Plate 3 is rotated so that the Protrusion Block 5 is resting on the masa. The Handle 1 is then pressed against the Fulcrum Block 4 to compress the masa into the shape of Cavity 6 through pressure from the Protrusion Block 5.

In one embodiment, there is an additional separate component that is used in the apparatus. A piece of plastic sheeting or liner, slightly larger in width and length than the apparatus, is used to prevent sticking of the masa. The liner has a thickness that is similar to a plastic grocery bag. The liner's function is to make sure the portion of masa doesn't stick to the Protrusion Block 5. When Protrusion Block 5 is compressed into the Cavity 6, the liners are placed in between to cover the portion of masa. Once the Protrusion Block 5 is reopened, the liner is removed from the masa. The newly formed masa is pressed onto a corn husk, and now the cornhusk is ready to be removed from the Tamal maker machine.

The Handle 1 is then rotated back to an upright position, the Compression Plate 3 is lifted and rotated away, and the formed masa can be retrieved and wrapped to complete the tamale making process.

In one embodiment, the Cavity 6 may be somewhat oval shaped, with one end slightly flattened. The Protrusion Block 5 has a similar perimeter shape, although slightly smaller so as to fit into the Cavity. The thickness of the Protrusion Block 5 is such that it does not touch the bottom of the Cavity when the Compression Plate 3 is fully engaging the Base Plate 2. In one embodiment, there is at least a 2-4 centimeters gap at the point of greatest insertion of the Protrusion Block 5 into Cavity 6.

The press may have different shaped cavities as desired, to produce masa forms of the desired shape and size.

What is claimed is:

1. A tamale press comprising:
a Base Plate having a Cavity formed therein;
a Handle hingedly coupled to the Base Plate at a first end thereof;
a Compression Plate hingedly coupled to the Base Plate at a second end thereof, the Compression Plate having a Protrusion Block formed on a first surface thereof to insert into the Cavity.

2. The tamale press of claim 1 wherein the Compression Plate further including a Fulcrum Block formed on a second surface thereof.

3. The tamale press of claim 2 wherein the Handle engages the Fulcrum Block to apply pressure to the Compression Plate.

4. The tamale press of claim 1 wherein the tamale press is comprised of wood.

5. The tamale press of claim 1 wherein the tamale press is comprised of metal.

6. The tamale press of claim 1 wherein the tamale press is comprised of plastic.
